(19) United States
(12) Patent Application Publication
(10) Pub. No.: US 2006/0207033 A1
(43) Pub. Date: Sep. 21, 2006

(54) Polyorganosiloxanes

(76) Inventors: Harald Chrobaczek, Augsburg (DE); Gunther Tschida, Schwabmunchen (DE); Petr Kvita, Reinach (CH); Mario Dubini, Niederdorf (CH); Rolf Strub, Reinach (CH); Eduard Weiss, Grenzach-Wyhlen (DE); Gabriele Lindmair, Meitingen (DE); Ralf Goretzki, Stadtbergen (DE)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/562,539

(22) PCT Filed: Jun. 25, 2004
(86) PCT No.: PCT/EP04/51235

§ 371 Date: May 31, 2006

(30) Foreign Application Priority Data
Jul. 4, 2003 (EP) 03102012.6

(51) Int. Cl. B05D 3/02; C11D 3/00

(52) U.S. Cl. 8/115.51; 427/384

(57) ABSTRACT

The invention relates to polyorganosiloxanes having a concentration of nitrogen of >0.8% by weight (wt-%), based on the total weight of the polyorganosiloxane, to compositions comprising such polyorganosiloxanes and to the treatment of fiber materials with such compositions.

The invention relates to polyorganosiloxanes having a concentration of nitrogen of >0.8% by weight (wt-%), based on the total weight of the polyorganosiloxane, to compositions comprising such polyorganosiloxanes and to the treatment of fiber materials with such compositions.

In DE 19652524A1, compositions comprising polyorganosiloxanes having a concentration of nitrogen in the polyorganosiloxane of 0.21 and 0.8 wt-%, based on the total amount of polyorganosiloxane, are explicitly disclosed.

The known polyorganosiloxanes do still show some disadvantages. Therefore, the goal of the present patent application was to provide polyorganosiloxanes with improved properties. Such properties are i.e. the recovery angle of the treated fabric, hydrophilicity, antistatic and softness of the treated fabric.

The invention relates to polyorganosiloxanes having the following formula (I) 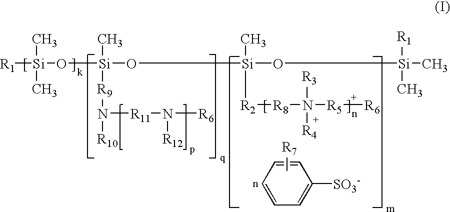
in which said structural units may be distributed over the polysiloxane chain in any order, in which

each R₁ is independently from each other —OH; —OC₁-C₈alkyl or —CH₃,

R₂ is a linear or branched C₁-C₁₆alkylene,

R₃ and R₄ are independently from each other linear C₁-C₈alkyl; branched or cyclic C₃-C₈alkyl;

R₅ and R₈ are independently from each other linear or branched C₁-C₁₆alkylene,

R₆ and R₇ are independently from each other H; linear C₁-C₈alkyl; branched or cyclic C₃-C₈alkyl,

R₉ is a linear or branched C₁-C₁₆alkylene,

R₁₀ and R₁₂ are independently from each other H; linear C₁-C₈alkyl; branched or cyclic C₃-C₈alkyl,

R₁₁ is a linear or branched C₁-C₁₆alkylene,

n is 1, 2 or 3,

p is 0, 1 or 2,

the sum of k, m and q is 25 to 900,

whereby the concentration of nitrogen in the polyorganosiloxane is >0.8 wt-%, based on the total weight of the polyorganosiloxane.

Linear C₁-C₈alkyl can be methyl, ethyl, propyl, butyl, propyl, pentyl, hexyl or octyl.

Branched C₃-C₈alkyl can be any possible isomer of linear C₃-C₈alkyl. Examples are —CH(CH₃)₂, —CH(CH₃)CH₂CH₃, —(CH₂)₁₋₅CH(CH₃)₂, —C(CH₃)₃, —(CH₂)₁₋₄CH(CH₃)CH₂CH₃, —CH(CH₃)(CH₂)₁₋₅CH₃, —CH(CH₃)(CH₂)₁₋₃CH(CH₃)₂, C(CH₃)₂(CH₂)₁₋₄CH₃ and —(CH₂)₁₋₄C(CH₃)₃.

Cyclic C₃-C₈alkyl can be cyclopropyl, cyclobutyl, cyclopentyl, cyclohexyl, cycloheptyl or cyclooctyl. Preferably cyclopentyl, cyclohexyl, cycloheptyl or cyclooctyl as well as alkyl substituted C₄-C₇cylcoalkyl moieties.

Linear or branched C₁-C₁₆alkylene can be methylene, ethylene, propylene, butylene, pentylene, hexylene, heptylene, octylene, nonylene, decanylene, undecanylene, dodecanylene, tridecanylene, tetradecanylene, pentadecanylene and hexadecanylene as well as all possible branched isomers thereof.

Preferably, R₂ is a linear or branched C₁-C₁₂alkylene, more preferably C₁-C₈alkylene, especially preferred C₁-C₄alkylene.

Preferably, R₃ and R₄ are independently from each other linear or branched C₁-C₆alkyl or cyclic C₄-C₈alkyl, more preferably linear or branched C₁-C₄alkyl or cyclopentyl, cyclohexyl or cyclooctyl.

Preferably, R₅ and R₈ are independently from each other linear or branched C₁-C₁₂alkylene, more preferably C₁-C₈alkylene, especially preferred C₁-C₄alkylene.

Preferably, R₆ and R₇ are independently from each other H; linear or branched C₁-C₆alkyl or cyclic C₄-C₈ alkyl, more preferably H; linear or branched C₁-C₄alkyl or cyclopentyl, cyclohexyl or cyclooctyl.

Preferably, R₉ is linear or branched C₁-C₁₂alkylene, more preferably C₁-C₈alkylene, especially preferred C₁-C₄alkylene.

Preferably, R₁₀ and R₁₂ are independently from each H; linear or branched C₁-C₆alkyl or cyclic C₄-C₈ alkyl, more preferably H; linear or branched C₁-C₄alkyl or cyclopentyl, cyclohexyl or cyclooctyl.

Preferably, R₁₁ is linear or branched C₁-C₁₂alkylene, more preferably C₁-C₈alkylene, especially preferred C₁-C₄alkylene.

Preferably, n is 1, 2 or 3.

Preferably, p is 0, 1 or 2.

Preferably, the sum of k, m and q is 25 to 700, more preferably the sum of k, m and p is 25 to 500.

Preferably, the polyorganosiloxanes of the present invention have a concentration of nitrogen of ≧1 wt-%, more preferably of ≧1.5 wt-%, especially preferred of ≧1.5 wt-% and <8 wt-%, very especially preferred of ≧1.5 wt-% and <5 wt-%, always based on the total weight of the polyorganosiloxane.

A preferred embodiment of the present invention relates to polyorganosiloxanes having the following formula (I) 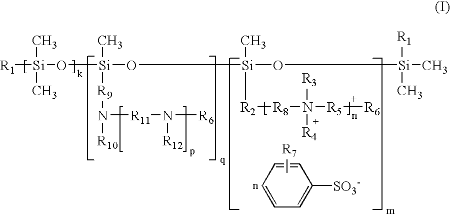
in which said structural units may be distributed over the polysiloxane chain in any order, in which

each R₁ is independently from each other —OH; —OC₁-C₄alkyl or —CH₃,

R₂ is a linear or branched C₁-C₈alkylene,

R₃ and R₄ are independently from each other linear or branched C₁-C₆alkyl or cyclic C₄-C₈alkyl,

R₅ and R₈ are independently from each other linear or branched C₁-C₈alkylene,

R₆ and R₇ are independently from each other H; linear or branched C₁-C₈alkyl or cyclic C₄-C₈ alkyl,

R₈ is linear or branched C₁-C₈alkylene,

R₁₀ and R₁₂ are independently from each H; linear or branched C₁-C₆alkyl or cyclic C₄-C₈ alkyl,

R₁₁ is linear or branched C₁-C₈alkylene,

n is 1, 2 or 3,

p is 0, 1 or 2,

the sum of k, m and q is 25 to 700, whereby the concentration of nitrogen in the polyorganosiloxane is ≧1 wt-%, based on the total weight of the polyorganosiloxane.

A more preferred embodiment of the present invention relates to polyorganosiloxanes having the following formula (I) 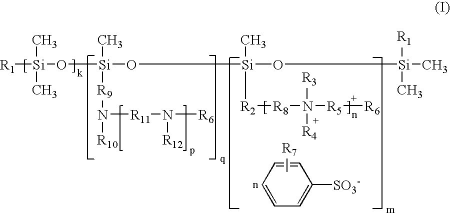
in which said structural units may be distributed over the polysiloxane chain in any order, in which

each R₁ is independently from each other —OH; —OC₁-C₂alkyl or —CH₃,

R₂ is a linear or branched C₁-C₄alkylene,

R₃ and R₄ are independently from each other linear or branched C₁-C₄alkyl; cyclopentyl; cyclohexyl or cyclooctyl,

R₅ and R₈ are independently from each other linear or branched C1-C₄alkylene,

R₆ and R₇ are independently from each other H; linear or branched C₁-C₄alkyl; cyclopentyl; cyclohexyl or cyclooctyl,

R₉ is linear or branched C₁-C₄alkylene,

R₁₀ and R₁₂ are independently from each H; linear or branched C₁-C₄alkyl; cyclopentyl; cyclohexyl or cyclooctyl,

R₁₁ is linear or branched C₁-C₄alkylene,

n is 1, 2 or 3,

p is 0 or 1,

the sum of k, m and q is 25 to 700, whereby the concentration of nitrogen in the polyorganosiloxane is ≧1.5 wt-%, based on the total weight of the polyorganosiloxane.

A more preferred embodiment of the present invention relates to polyorganosiloxanes having the following formula (I) 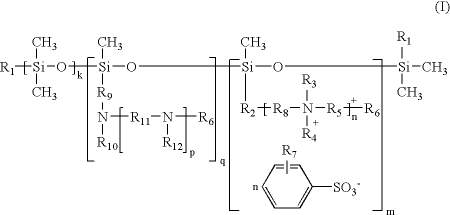
in which said structural units may be distributed over the polysiloxane chain in any order, in which

each R₁ is independently from each other —OH or —CH₃,

R₂ is a linear or branched C₁-C₄alkylene,

R₃ and R₄ are independently from each other linear or branched C₁-C₄alkyl; cyclopentyl; cyclohexyl or cyclooctyl,

R₅ and R₈ are independently from each other linear or branched C₁-C₄alkylene,

R₆ and R₇ are independently from each other H; linear or branched C₁-C₄alkyl; cyclopentyl; cyclohexyl or cyclooctyl,

R₉ is linear or branched C₁-C₄alkylene,

R₁₀ and R₁₂ are independently from each H; linear or branched C₁-C₄alkyl; cyclopentyl; cyclohexyl or cyclooctyl,

R₁₁ is linear or branched C₁-C₄alkylene,

n is 1, 2 or 3,

p is 0 or 1,

the sum of k, m and q is 25 to 500, whereby the concentration of nitrogen in the polyorganosiloxane is ≧1.5 wt-% and <8 wt-%, based on the total weight of the polyorganosiloxane.

A further embodiment of the present invention is a composition comprising at least one of the above defined polyorganosiloxanes.

Such compositions are preferably aqueous solutions or dispersions, which preferably contain from 2 wt-% to 60 wt-% of at least one of the polyorganosiloxane of formula (I) as defined by the invention. Depending on the chemical nature of the polyorganosiloxane it is possible that the latter is soluble or self-dispersible in water. In the other cases, highly stable aqueous dispersions can be obtained by adding one or several dispersing agents. Suitable as dispersants are surface-active compounds known to the expert in the field of silicone emulsions. Non-ionogenic products such as fatty alcohol ethoxylates, fatty acid ethoxylates, or ethoxylated fatty amines, or cation-active dispersants such as, for example quaternized ammonium salts have to be mentioned here in particular. The amount of dispersant is in the range of, for example from 2 wt-% to 10 wt-% based on the total dispersion. The dispersions can be produced by generally known methods employed for dispersing polyorganosiloxanes. Polyorganosiloxanes of formula (I) as defined by the invention in the form of aqueous dispersions or solutions are excellently suitable for treating fiber materials, in particular flat textile structures within the framework of textile finishing or dressing. For such purposes, the solutions or dispersions may contain also other products known in the field of textile dressing such as, for example polymers with perfluoroalkyl groups for achieving oil-repelling properties; fatty acid alkanolamides; waxes in the dispersed form, or other polyorganosiloxanes. The aqueous solutions or dispersions can be applied to the fiber materials, and further processing can be carried out by generally known methods. Such aqueous solutions or dispersions are preferably applied by means of a padding process. The fiber materials are preferably flat textile structures in the form of woven or knitted fabrics, which may consist of cellulose, in particular cotton, synthetic polymers, or mixtures of said fibers.

Polyorganosiloxanes of formula (I) as defined by the invention are flowable. This means that they are either liquid or at least flowable at room temperature and thus do not have a solid or pasty consistency.

The compositions according to the present invention comprise from 2 to 60 wt-%, preferably from 5-50 wt-%, more preferably from 10-40 wt-%, of at least one of the polyorganosiloxanes of formula (I) as defined by the invention, based on the total weight of the composition.

The polyorganosiloxanes according to formula (I) as well as their production are known. The composition can be produced in analogy to known processes. Such a process is for example disclosed in DE 19652524A1.

The compositions according to the present invention may further comprise buffers; hydrotropica, such as polyfunctional alcohol, i.e. 1,2-propylenglycol or dipropylenglycol; organic or inorganic acid, such as formic acid, acetic acid, glycol acid, oxalic acid, citric acid, citric acid, lactic acid, hydrochloric acid, sulfuric acid or phosphoric acid; and further common auxiliaries depending on the use.

A further embodiment of the present invention, are softener compositions comprising
a) at least one fabric softener; and
b) an aqueous composition as defined above.

Fabric softeners, especially hydrocarbon fabric softeners, suitable for use herein are selected from the following classes of compounds:

(i) Cationic quaternary ammonium salts. The counter ion of such cationic quaternary ammonium salts may be a halide, such as chloride or bromide, methyl sulphate, or other ions well known in the literature. Preferably the counter ion is methyl sulfate or any alkyl sulfate or any halide, methyl sulfate being most preferred for the dryer-added articles of the invention.

Examples of cationic quaternary ammonium salts include but are not limited to:

(1) Acyclic quaternary ammonium salts having at least two C₈ to C_{30,} preferably C₁₂ to C₂₂ alkyl or alkenyl chains, such as: ditallowdimethyl ammonium methylsulfate, di(hydrogenated tallow)dimethyl ammonium methylsulfate, di(hydrogenated tallow)dimethyl ammonium methylchloride, distearyldimethyl ammonium methyl-sulfate, dicocodimethyl ammonium methylsulfate and the like. It is especially preferred if the fabric softening compound is a water insoluble quaternary ammonium material which comprises a compound having two C₁₂ to C₁₈ alkyl or alkenyl groups connected to the molecule via at least one ester link. It is more preferred if the quaternary ammonium material has two ester links present. An especially preferred ester-linked quaternary ammonium material for use in the invention can be represented by the formula: 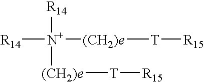
wherein each R₁₄ group is independently selected from C₁ to C₄ alkyl, hydroxyalkyl or C₂ to C₄ alkenyl groups; T is either —O—C(O)— or —C(O)—O—, and wherein each R₁₅ group is independently selected from C₈ to C₂₈ alkyl or alkenyl groups; and e is an integer from 0 to 5.

A second preferred type of quaternary ammonium material can be represented by the 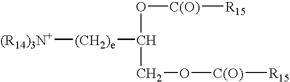
wherein R₁₄, e and R₁₅ are as defined above.

(2) Cyclic quaternary ammonium salts of the imidazolinium type such as di(hydrogenated tallow)dimethyl imidazolinium methylsulfate, 1-ethylene-bis(2-tallow-1-methyl)imidazolinium methylsulfate and the like;

(3) Diamido quaternary ammonium salts such as: methyl-bis(hydrogenated tallow amidoethyl)-2-hydroxethyl ammonium methyl sulfate, methyl bi(tallowamidoethyl)-2-hydroxypropyl ammonium methylsulfate and the like;

(4) Biodegradable quaternary ammonium salts such as N,N-di(tallowoyl-oxy-ethyl)-N,N-dimethyl ammonium methyl sulfate and N,N-di(tallowoyl-oxy-propyl)-N,N-dimethyl ammonium methyl sulfate. Biodegradable quaternary ammonium salts are described, for example, in U.S. Pat. Nos. 4,137,180, 4,767,547 and 4,789,491 incorporated by reference herein.

Preferred biodegradable quaternary ammonium salts include the biodegradable cationic diester compounds as described in U.S. Pat. No. 4,137,180, herein incorporated by reference.

(ii) Tertiary fatty amines having at least one and preferably two C₈ to C₃₀, preferably C₁₂ to C₂₂ alkyl chains. Examples include hardened tallow-di-methylamine and cyclic amines such as 1-(hydrogenated tallow)amidoethyl-2-(hydrogenated tallow) imidazoline. Cyclic amines, which may be employed for the compositions herein, are described in U.S. Pat. No. 4,806,255 incorporated by reference herein.

(iii) Carboxylic acids having 8 to 30 carbons atoms and one carboxylic group per molecule. The alkyl portion has 8 to 30, preferably 12 to 22 carbon atoms. The alkyl portion may be linear or branched, saturated or unsaturated, with linear saturated alkyl preferred. Stearic acid is a preferred fatty acid for use in the composition herein. Examples of these carboxylic acids are commercial grades of stearic acid and palmitic acid, and mixtures thereof, which may contain small amounts of other acids.

(iv) Esters of polyhydric alcohols such as sorbitan esters or glycerol stearate. Sorbitan esters are the condensation products of sorbitol or iso-sorbitol with fatty acids such as stearic acid. Preferred sorbitan esters are monoalkyl. A common example of sorbitan ester is SPANS®60 (ICI) which is a mixture of sorbitan and isosorbide stearates.

(v) Fatty alcohols, ethoxylated fatty alcohols, alkylphenols, ethoxylated alkylphenols, ethoxylated fatty amines, ethoxylated monoglycerides and ethoxylated diglycerides.

(vi) Mineral oils, and polyols such as polyethylene glycol.

These softeners are more definitively described in U.S. Pat. No. 4,134,838 the disclosure of which is incorporated by reference herein. Preferred fabric softeners for use herein are acyclic quaternary ammonium salts. Mixtures of the above mentioned fabric softeners may also be used.

The fabric softening composition employed in the present invention preferably contains about 0.1 to about 95 wt-%, based on the total weight of the fabric softening composition, of the fabric softening component. Preferred is an amount of 0.5 to 50 wt-%, especially an amount of 2 to 50 wt-% and most preferably an amount of 2 to 30 wt-%.

The amount of the polyorganosiloxanes of formula (I) in the fabric softening composition is preferably from 0.01 to 50 wt-%, based on the total weight of the fabric softening composition. Preferred is an amount of 0.01 to 30 wt-%, especially an amount of 0.05 to 30 wt-% and most preferably an amount of 0.05 to 18 wt-%.

The fabric softening composition may also comprise additives which are customary for standard commercial fabric softening compositions, for example alcohols, such as ethanol, n-propanol, i-propanol, polyhydric alcohols, for example glycerol and propylene glycol; amphoteric and nonionic surfactants, for example carboxyl derivatives of imidazole, oxyethylated fatty alcohols, hydrogenated and ethoxylated castor oil, alkyl polyglycosides, for example decyl polyglucose and dodecylpolyglucose, fatty alcohols, fatty acid esters, fatty acids, ethoxylated fatty acid glycerides or fatty acid partial glycerides; also inorganic or organic salts, for example water-soluble potassium, sodium or magnesium salts, non-aqueous solvents, pH buffers, perfumes, dyes, hydrotropic agents, antifoams, anti redeposition agents, enzymes, optical brighteners, antishrink agents, stain removers, germicides, fungicides, dye fixing agents or dye transfer inhibitors (as described in WO-A-02/02865), antioxidants, corrosion inhibitors, wrinkle recovery or wet soiling reduction agent, such as polyorganosiloxanes. The latter two additives are described in WO0125385.

Such additives are preferably used in an amount of 0 to 30 wt-%, based on the total weight of the fabric softening composition. Preferred is an amount of 0 to 20 wt-%, especially an amount of 0 to 10 wt-% and most preferably an amount of 0 to 5 wt-%, based on the total weight of the fabric softening composition.

The fabric softener compositions are preferably in liquid aqueous form. The fabric softener compositions preferably have a water content of 25 to 90 wt-%, based on the total weight of the composition. More preferably the water content is 50 to 90 wt-%, especially 60 to 90 wt-%.

Therefore, an embodiment of the present invention is also a fabric softener composition comprising
(a) 0.1 to about 95 wt-%, based on the total weight of the fabric softening composition, of at least one fabric softening component,
(b) 0.01 to 50 wt-%, based on the total weight of the fabric softening composition, of at least one polyorganosiloxane of formula (I),
(c) 0 to 30 wt-%, based on the total weight of the fabric softening composition, of at least one further additive,
(d) 25 to 90 wt-%, based on the total weight of the fabric softening composition, of water.

Therefore, a more preferred embodiment of the present invention is a fabric softener composition comprising
(a) 2 to 50 wt-%, based on the total weight of the fabric softening composition, of at least one fabric softening component,
(b) 0.01 to 30 wt-%, based on the total weight of the fabric softening composition, of at least one polyorganosiloxane of formula (I),
(c) 0 to 20 wt-%, based on the total weight of the fabric softening composition, of at least one further additive such as for example alcohols; amphoteric and nonionic surfactants; inorganic or organic salts; non-aqueous solvents; pH buffers; perfumes; dyes; hydrotropic agents; antifoams; ant redeposition agents; enzymes; optical brighteners; antishrink agents; stain removers; germicides; fungicides; dye fixing agents or dye transfer inhibitors; antioxidant corrosion inhibitor; wrinkle recovery or wet soiling reduction agent,
(d) 50 to 90 wt-%, based on the total weight of the fabric softening composition, of water.

Therefore, an especially preferred embodiment of the present invention is a fabric softener composition comprising
(a) 2 to 30 wt-%, based on the total weight of the fabric softening composition, of at least one fabric softening component,
(b) 0.05 to 18 wt-%, based on the total weight of the fabric softening composition, of at least one polyorganosiloxane of formula (I),
(c) 0 to 5 wt-%, based on the total weight of the fabric softening composition, of at least one further additive such as for example alcohols; amphoteric and nonionic surfactants; inorganic or organic salts; non-aqueous solvents; pH buffers; perfumes; dyes; hydrotropic agents; antifoams; anti redeposition agents; enzymes; optical brighteners; antishrink agents; stain removers; germicides; fungicides; dye fixing agents or dye transfer inhibitors; antioxidant corrosion inhibitor; wrinkle recovery or wet soiling reduction agent,
(d) 60 to 90 wt-%, based on the total weight of the fabric softening composition, of water.

The fabric softener compositions preferably have a pH value from 2.0 to 9.0, especially 2.0 to 5.0.

The fabric softener compositions can, for example, be prepared as follows: Firstly, an aqueous formulation of the polysiloxane(s) of formula (I) is prepared as described above. The fabric softener composition according to the invention is usually, but not exclusively, prepared by firstly stirring the active substance, i.e. the hydrocarbon based fabric softening component, in the molten state into water, then, where required, adding further desired additives and, finally, adding the formulation of the polysiloxane(s) of formula (I). The fabric softener composition can, for example, also be prepared by mixing a preformulated fabric softener with the polysiloxane(s) of formula (I).

These fabric softener compositions are traditionally prepared as dispersions containing for example up to 30 wt-% of active material in water. They usually have a turbid appearance. However, alternative formulations usually containing actives at levels of 5 to 40 wt-% along with solvents can be prepared as microemulsions, which have a clear appearance (as to the solvents and the formulations see for example U.S. Pat. No. 5,543,067 und WO-A-98/17757).

Examples of suitable textile fibre materials which can be treated with the liquid rinse conditioner composition are materials made of silk, wool, polyamide, acrylics or polyurethanes, and, in particular, cellulosic fibre materials of all types. Such fibre materials are, for example, natural cellulose fibres, such as cotton, linen, jute and hemp, and regenerated cellulose. Preference is given to textile fibre materials made of cotton. The fabric softener compositions are also suitable for hydroxyl-containing fibres which are present in mixed fabrics, for example mixtures of cotton with polyester fibres or polyamide fibres.

The recovery angle of the textile treated with these compositions are improved.

Referring to the following Examples, given by way of illustration, will have a better understanding of the present invention and of its many advantages. The percentages given in the examples are percentages by weight.

### EXAMPLE 1

### Preparation of the Rinse Conditioners

The liquid rinse conditioners are prepared by using the procedure described below. This type of fabric rinse conditioners is normally known under the name of “triple strength” or “triple fold” formula.

75 g of water is heated to 40° C. 15 g of the molten fabric softener Di-(nortallow carboxy-ethyl-)hydroxyethyl-methylammonium-methosulfate (Rewoquate®WE 18 available from Witco) is added to the heated water under stirring and the mixture is stirred for 1 hour at 40° C. Afterwards the aqueous softener solution is cooled down to below 30° C. while stirring. When the solution cools down 0.1 g of magnesium chloride is added and the pH is adjusted to 3.2 with 0.1 N hydrochloric acid. The formulation is then filled up with water to 100 g.

The rinse conditioner formulation as described above was used as a base formulation. In a final step the fabric softener is mixed with a separately prepared “PDMS”-Formulation. The fabric softener formulations used in the following examples are listed in the following Table 1.

TABLE 1
(rinse conditioner formulations used in the application test for 1 kg
wash load)

| Rinse | | Fabric | |
|---|---|---|---|
| conditioner | “PDMS”-Formulation (calculated on | softener Base | |
| formulation | solid content of the formulation) | Formulation | pH |
| A | 0.28 g of Type I | 14 g | 3.2 |
| B | 0.28 g of Type II | 14 g | 3.2 |
| C | 0.28 g of Type III | 14 g | 3.2 |
| D | 0.28 g of Type IV | 14 g | 3.2 |

Types of “PDMS”-Formulation used

Type I (State of the Art):

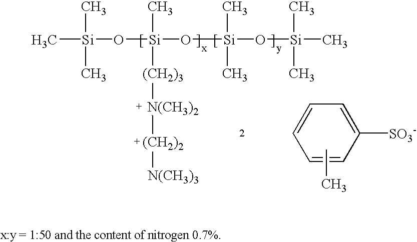

Type II:

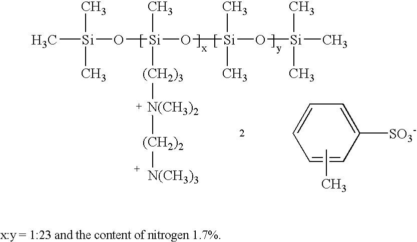

Type III:

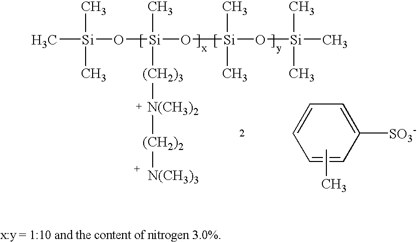

Type IV:

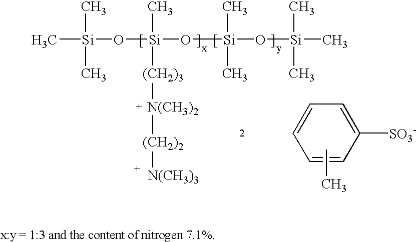

### EXAMPLE 2

### Improvement of Crease Recovery Angle

The formulated rinse conditioners (see Table 1) are applied according to the following procedure:

Woven cotton (without textile finishing, 120 g/m²) swatches of size of 34 cm by 34 cm are washed together with ballast material (cotton and cotton/polyester) in an AEG Oeko Lavamat 73729 washing machine maintaining the washing temperature at 40° C. The total fabric load of 1 kg is washed for 15 minutes with 33 g of ECE Color Fastness Test Detergent 77 (Formulation January 1977, according to ISO 105-CO6). The rinse conditioner formulation as described in Table 1 is applied in the last rinse cycle at 20° C. After rinsing with the formulation the textile swatches are dried on a washing line at ambient temperature. Evaluation of crease recovery angle

TABLE 2
(Results of the evaluation of crease recovery angle on cotton/polyester
by DIN 53890 method, 1 kg loading, 30 minutes relaxing)

| Sample of rinse | Crease recovery angle(mean value |
|---|---|
| conditioner formulation | of warp and weft) |
| A (Prior Art) | 63 |
| B | 71 |
| C | 71 |
| D | 70 |

The above results show a marked improvement in crease recovery angle of sample B to D for the textile fabric material treated with compositions of the present invention.

1. A polyorganosiloxane having the following formula (I): 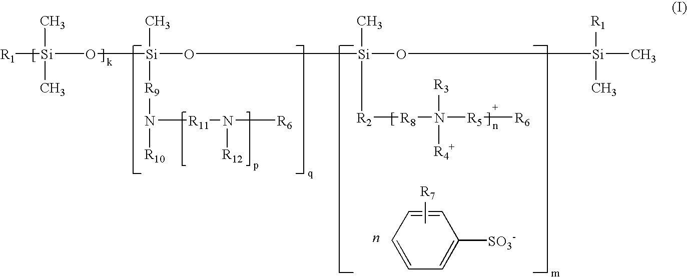
H₃ CH₃ CH₃ RI NRH₃ R₃ +CH₃
in which the structural units may be distributed over the polysiloxane chain in any order, in which
each R₁ is independently from each other —OH; —OC₁-C₈alkyl or —CH₃,
R₂ is a linear or branched C₁-C₁₆alkylene,
R₃ and R4 are independently from each other linear C₁-C₈alkyl; branched or cyclic C₃-C₈alkyl;
R₅ and R8 are independently from each other linear or branched C₁-C₁₆alkylene,
R₆ and R₇ are independently from each other H; linear C₁-C₈alkyl; branched or cyclic C₃-C₈alkyl,
R₉ is a linear or branched C₁-C₁₆alkylene,
R₁₀ and R₁₂ are independently from each other H; linear C₁-C₈alkyl; branched or cyclic C₃-C₈alkyl,
R₁₁ is a linear or branched C₁-C₁₆alkylene,
n is 1, 2 or 3,
p is 0, 1 or 2,
the sum of k, m and q is 25 to 900,
whereby the concentration of nitrogen in the polyorganosiloxane is ≧1.5 wt-%, based on the total weight of the polyorganosiloxane.

2. A polyorganosiloxane according to claim 1, wherein
R₂ is a linear or branched C₁-C₁₂alkylene;
R₃ and R4 are independently from each other linear or branched C₁-C₆alkyl or cyclic C₄-C₈ alkyl;
R₅ and R8 are independently from each other linear or branched C₁-C₁₂alkylene;
R₆ and R₇ are independently from each other H; linear or branched C₁-C₆alkyl or cyclic C₄-C₈ alkyl;
R₉ is a linear or branched C₁-C₁₂alkylene;
R₁₀ and R₁₂ are independently from each other H; linear or branched C₁-C₆alkyl or cyclic C₄-C₈alkyl; and
R₁₁ is a linear or branched C₁-C₁₂alkylene.

3. A polyorganosiloxane according to claim 1, wherein the concentration of nitrogen is ≧1 wt-%, based on the total weight of the polyorganosiloxane.

4. (canceled)

5. A polyorganosiloxane according to claim 1, wherein the concentration of nitrogen is ≧1.5 wt-% and <8 wt-%, based on the total weight of the polyorganosiloxane.

6. A polyorganosiloxane according to claim 1, wherein the concentration of nitrogen is ≧1.5 wt-% and <5 wt-%, based on the total weight of the polyorganosiloxane.

7. A polyorganosiloxane according to claim 1, wherein the sum of k, m and q is 25 to 700.

8. A composition comprising at least one polyorganosiloxane as defined in claim 1 and an adjuvant or diluent.

9. A composition according to claim 8, comprising from 2 wt-% to 60 wt-%, based on the total weight of the composition of the polyorganosiloxane.

10. A composition according to claim 8, comprising at least one fabric softener.

11. A composition according to claim 10, comprising about 0.1 to about 95 wt-%, based on the total weight of the composition, of the fabric softening component.

12. A composition according to claim 8, comprising 0 to 30 wt-%, based on the total weight of the composition, of at least one additive which is customary for standard commercial fabric softening compositions.

13. A composition according to claim 8, comprising 25 to 90 wt-%, based on the total weight of the composition, of water.

14. A composition according to claim 13, wherein the pH-value is from 2.0 to 9.0.

15. (canceled)

16. A method for the treatment of textile material, which comprises contacting said material with a composition according to claim 8.

17. A method according to claim 16, wherein the composition comprises at least one fabric softener.

18. A method according to claim 17, wherein the composition additionally comprises at least one additive which is customary for standard commercial fabric softening compositions.
